(19) United States
(12) Patent Application Publication
(10) Pub. No.: US 2011/0010429 A1
(43) Pub. Date: Jan. 13, 2011

(54) Method and apparatus for caching multimedia content from the internet on occasionally-connected devices

(76) Inventor: Steven E. Barile, Portland, OR (US)

Correspondence Address: INTEL CORPORATION;c/o CPA Global, P.O. BOX 52050, MINNEAPOLIS, MN, 55402, US

(21) Appl. No.: 12/655,469

(22) Filed: Dec. 30, 2009

Related U.S. Application Data
(63) Continuation of application No. 10/600,179, filed on Jun. 20, 2003.

(51) Int. Cl. G06F 15/16

(52) U.S. Cl. 709/217

(57) ABSTRACT

An arrangement is provided for caching multimedia content on occasionally connected devices. A play list is created and submitted to a multimedia content provider that provides and processes the desired multimedia content in the play list before the desired content is downloaded to a device. The device need only connect to the multimedia content provider for a period required to download the desired multimedia content. Once the desired multimedia content is in the device, the device can be carried with a user so that the user can access the multimedia content anywhere.

### RELATED APPLICATIONS

The present application is a continuation of pending U.S. patent application Ser. No. 10/600,179, titled “Method And Apparatus For Caching Multimedia Content From The Internet On Occasionally-Connected Devices”, filed on Jun. 20, 2003. The present application is related to U.S. patent application Ser. No. 12/590,234, titled “Method of and Apparatus for Rating Songs on Internet Radio and Downloading Related Content”, filed on Nov. 4, 2009 and U.S. patent application Ser. No. 12/590,235, titled “Method of and Apparatus for Rating Songs on Internet Radio and Downloading Related Content”, filed on Nov. 4, 2009. These applications are entirely incorporated by reference.

### BACKGROUND

1.Field

The present invention relates generally to online multimedia broadcasting and, more specifically, to caching multimedia content on occasionally-connected devices.

2. Description

With more mobile devices (e.g., personal digital assistants (PDAs)) available, users desire more services for such devices. One desirable service is to give a mobile device user access to multimedia programs (e.g., music, news, videos, etc.), preferably according to the user's own choice. Intuitively, a user can prepare the multimedia content by his/her own. For example, a user can buy Compact Discs (CDs) and/or Digital Versatile Discs (DVDs) and convert audio/video content in these CDs/DVDs into playable multimedia content in his/her mobile devices. A user can also record multimedia programs from radios, televisions (TVs), and/or the Internet and make them playable from his/her mobile devices. However, multimedia content obtained in these manners is limited and is hard to update.

Internet radio is a recent application whereby individual digital audio files are streamed to users on client systems. A “radio program” via the Internet is a sequence of audio files (e.g., songs) that may be broadcast to all users, or narrowcast to a selected group of users. However, with Internet radio there is no way for an individual user to select other information to be interleaved with the songs, nor can the individual user specify all of the streaming multimedia content. Moreover, a user must constantly connect to the Internet in order to listen to audio files provided by an Internet radio station.

The Internet has become a resource for all types of multimedia content. However, it is not always possible or convenient for all mobile devices to connect to the Internet anytime and anywhere. Therefore, it is desirable to have a new way for mobile device users to access multimedia content from the Internet according to their own preferences.

### BRIEF DESCRIPTION OF THE DRAWINGS

The features and advantages of the present invention will become apparent from the following detailed description of the present invention in which:

FIG. 1 depicts a high-level framework of an exemplary system for caching multimedia content on occasionally-connected devices, according to an embodiment of the present invention;

FIG. 2 is an exemplary flow diagram of a process in which multimedia content is cached on occasionally-connected devices, according to an embodiment of the present invention;

FIG. 3 is a high-level functional block diagram of a play list creator that creates a title list of multimedia files, according to an embodiment of the present invention;

FIG. 4 is a high-level functional block diagram of a multimedia content provider, according to an embodiment of the present invention; and

FIG. 5 is a high-level functional block diagram of a multimedia content player that accesses and renders multimedia content in a multimedia content cache, according to an embodiment of the present invention;

### DETAILED DESCRIPTION

An embodiment of the present invention is a method and apparatus for caching multimedia content from the Internet on occasionally-connected devices. The present invention may be used to download multimedia content (MC) such as music, video, and news, based on a play list provided by a user or a content provider, to a portable device that is not permanently connected to the Internet. The play list may be created by a play list creator based on the user's preferences. The play list creator may be independent upon or be part of the content provider. The play list may also be pre-defined by the user or the content provider. The play list creator may help expand the user's play list by recommending to the user additional content based on the user's preferences or by cross-pollinating the user's play list with similar play lists from other users. The play list creator may further refine the user's play list based on the user's feedback on the recommended content.

When the user connects his/her device to the content provider through the Internet, the content provider may gather together all multimedia content in the user's play list, protect the content, and download the content to the user's device. The content provider may protect the content by using a digital right management (DRM) system, tamper-resistant software, or other encryption schemes. The scheme used to protect the multimedia content may prevent the content from being copied without permission or from being played where a license has expired.

The present invention may provide a user with occasionally-connected devices access to a large amount of multimedia content, based on the user's preferences, as if the user is constantly connected to the Internet.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

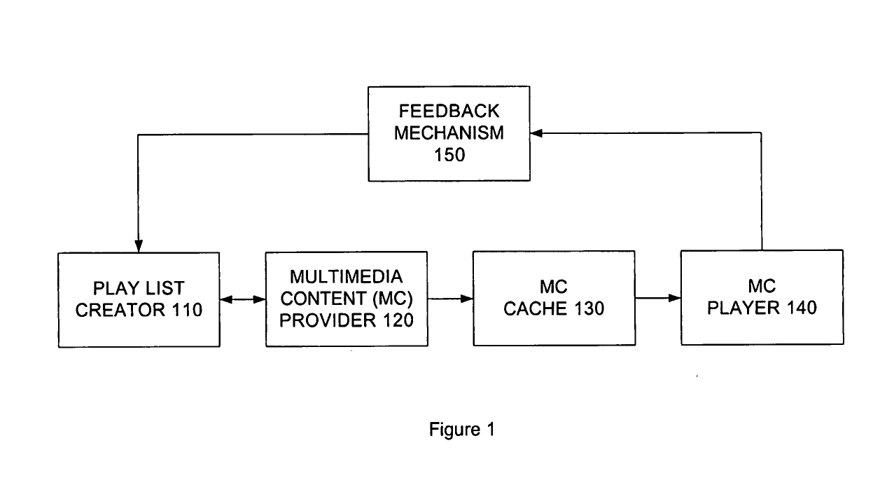

FIG. 1 depicts a high-level framework of an exemplary system for caching MC on occasionally-connected devices, according to an embodiment of the present invention. The system may comprise a play list creator 110, a multimedia content (MC) provider 120, an MC cache 130, an MC player 140, and a feedback mechanism 150.

The play list creator 110 may create a play list so that the MC provider 120 may provide MC based on the play list for a user to download the content to the MC cache 130. A play list may be a list of titles of multimedia files such as music, videos, and news. In one embodiment, the play list creator may create a play list according to a user's specifications. For example, the user may specify genres, artists, or titles for music; dates and subjects for news; and genres, actors, and titles for videos. In another embodiment, the play list creator may simply use a title list pre-determined by a user or a content provider as the play list. Additionally, the play list creator may expand a user's play list by recommending to the user additional titles and/or by cross-pollinating the user's play list with play lists of other users. For example, the play list creator may recommend to the user additional titles that are similar or related to the user's preferences. The play list creator may also recommend to the user additional titles from play lists of other users who have similar preferences to this user's. Moreover, the play list creator may refine a play list based on a user's feedback on content in the play list. For example, if the user does not like one title, the user can give a very low rating to this title so that the play list creator may remove this title from the play list of this user.

In one embodiment, the play list creator may provide a user interface for a user to enter specifications to define a play list, to input the user's own pre-defined play list, or to select one among provider pre-determined play lists. A user may also use the interface to rate titles in the play list. The user interface may be an interactive graphic interface, a speech recognition-based natural language dialog system, a handwriting recognition-based interactive system, or an interfacing system using a combination of several human-computer interaction technologies.

The MC provider 120 may accept a play list from a user and provide MC specified by the play list for the user to download to a MC cache 130. When receiving a request from a user to download a play list of titles, the MC provider may search a database for the titles in the play list and then gather multimedia files for these titles together. The multimedia files may comprise static and dynamic content such as music, video, broadcast news, sports, market information, and so on. The MC provider may also provide a header for each multimedia file. The header may comprise introductory information about a multimedia file (e.g., author, style, background, etc.).

The MC provider may further protect the multimedia files before allowing the user to download these files to an MC cache. In one embodiment, the MC provider may apply a typical encryption scheme to protect the files to be downloaded. In another embodiment, the MC provider may protect the files using tamper-resistant software. Yet in another embodiment, the MC provider may use a digital rights management (DRM) system to protect the files. A DRM system can allow a content provider to deliver music, videos, and other digital media content over the Internet in a protected format and also to facilitate consumers to obtain digital media files legitimately. In one embodiment, the protection scheme applied by the MC provider may be distinct for each title. For example, a first protection scheme may be provided for song 1, a second protection scheme may be applied to video 2, while a third protection scheme may be applied to news 1. The protection provided by the MC provider to a title may license the title to a specific user so that the title cannot be copied by others without permission from the MC provider. The license for the title may automatically expire after a certain period of time, if the user does not renew the license on time. Additionally, the MC provider may encode and/or compress the MC.

The MC cache 130 may download multimedia files from the MC provider and store these files. The MC cache may comprise a portable device. The MC cache may comprise a communication port, a receiving component, and a storage component. The communication port may enable the MC cache to connect to a network to download multimedia content from an MC provider. The receiving component may receive multimedia files downloaded from the MC provider, while the storage component may store these multimedia files. The storage component may comprise any type of storage medium such as recordable CDs, DVDs, tapes, and Static Random Access Memory (SRAM), Dynamic Random Access Memory (DRAM), flash memory, etc. In one embodiment, the MC cache may provide security protections for its content. For example, the MC cache may have an anti-theft component to prevent its content from being copied by an unauthorized party. In another embodiment, the MC cache may be unique for an MC player so that only an authorized player can access and play content stored in the MC cache.

The MC cache may download MC from the MC provider through a network. The network may be a local area network (LAN), a wide area network (WAN), the Internet, a terrestrial broadcast network such as a satellite communications network, or a wireless network. The MC cache only needs to connect to the network occasionally, but not constantly, in order to download the MC. For example, a user may connect to his home network (e.g., through wireless connection) and download a list of music to his car before he starts a trip. He may enjoy the music without connecting to a network during the trip. Additionally, the MC cache may check if there is any MC files already cached, and if there is, the MC cache may only need to update a license for such MC files so that a user can continue to access such MC files.

The MC player 140 may access and render MC stored in an MC cache to a user. The MC player may comprise an MC access module and an MC rendering mechanism. The MC access module may decrypt, decompress, and/or decode the MC in the MC cache so that the MC rendering mechanism may render the MC to the user. The MC player may be implemented in hardware or software. The MC player may be designed to work specifically with an MC cache or a general multimedia player. Additionally, the MC player may be a collection of several different media players, each for one type of media files. For example, a Motion Picture Expert Group (MPEG) audio layer 3 (MP3) player may be used to play MP3 formatted audio files, and a DVD player may be used to play DVD videos.

The MC player may be separate from the MC cache or these two may be bundled together. Both the MC player and the MC cache may reside in one device such as a computer. In one embodiment, an MC provider may provide an auto-installer script and a player application along with MC, with all being bundled together. When a user downloads the bundled unit to a computing machine, the auto-installer script may automatically install the player application. Subsequently, an access module in the player may decrypt, decompress, and/or decode the MC. Such an arrangement may ensure a secure access to the MC. In another embodiment, the MC player may comprise a text-to-speech component so that a text file can be rendered audibly to a user. Moreover, the MC player may also comprise a user interface so that a user can control how MC should be rendered. The user interface may use any type of human-machine interaction technologies (e.g., graphics, keyboard/mouse, buttons, natural language dialog, touch screen, etc.) or any combination of these technologies.

The feedback mechanism 150 may provide the play list creator 110 feedbacks about a play list from a user. The user may rate a title after learning introductory information about the title, if such information is available. The user may also rate a title after the title is partially or entirely rendered. The feedback mechanism may record the user's rating information and send the information to the play list creator. The feedback mechanism may reside together with the MC player and/or the MC cache.

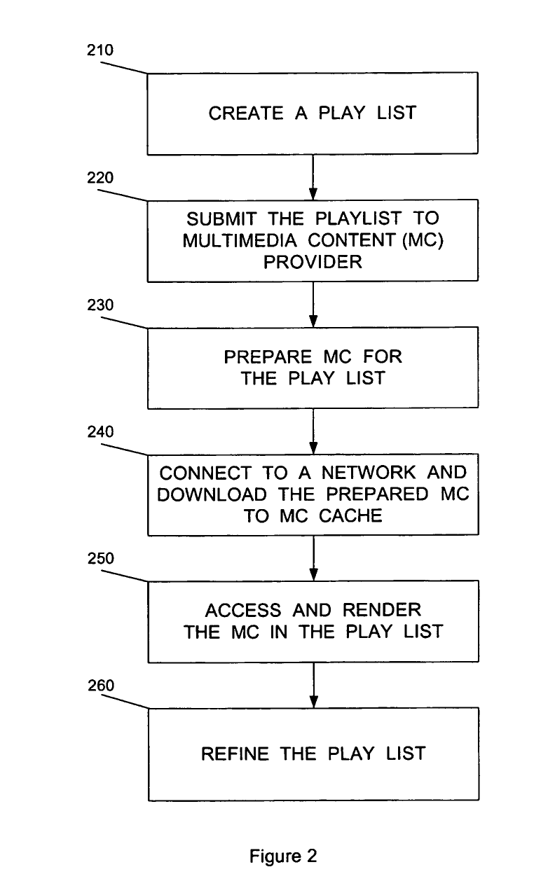

FIG. 2 is an exemplary flow diagram of a process in which MC is cached on occasionally-connected devices, according to an embodiment of the present invention. At step 210, a play list may be created. The play list may be created according to a user's specifications or by a user's selecting one of an MC provider's pre-determined play lists. The play list may also be expanded to include similar or related content based on a user's preference. At step 220, the play list may be submitted to the MC provider. At step 230, MC may be prepared by the MC provider for the play list. The preparation process may comprise searching a database for the MC in the play list, gathering the MC together, protecting the MC, compressing the MC, and/or encoding the MC. At step 240, the MC prepared for the play list may be downloaded to an MC cache. The MC cache is only required to connect to the MC provider through a network for a period long enough to complete downloading the MC. The MC cache may connect to the MC provider at a later time to download a new set of MC based on a new play list. At step 250, the MC in the play list may be accessed and rendered to the user. When being accessed, the MC may be decrypted, decompressed, and/or decoded. At step 260, the play list may be refined based on the user's feedback.

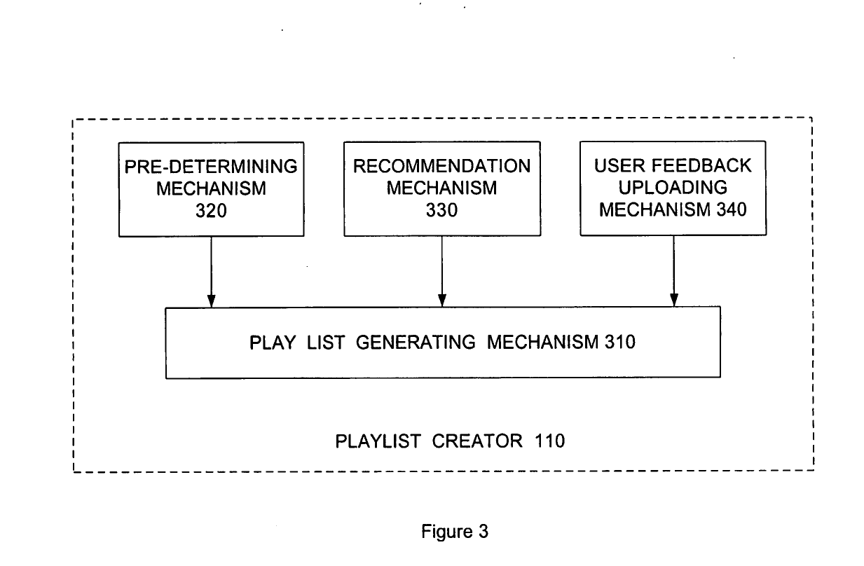

FIG. 3 is a high-level functional block diagram of a play list creator that creates a title list of multimedia files, according to an embodiment of the present invention. The play list creator may comprise a play list generating mechanism 310, a pre-determining mechanism 320, a recommendation mechanism 330, and a user feedback uploading mechanism 340. The play list generating mechanism may accept input from the other three components and actually generate a play list, which may comprise a list of multimedia file titles. The play list generating mechanism may comprise a component to allow a user to arrange the play list in the user's preferred manner. For example, the user may want to move certain titles around based on his preferences.

The pre-determining mechanism 320 may provide a user or a content provider a way to pre-determine a play list. In one embodiment, a user may import a play list from other systems here through the pre-determination mechanism. In another embodiment, a content provider may pre-define a number of play lists for users to choose from, according to the styles of MC. The content provider may also pre-define a number of play lists for market survey purposes. For example, the content provider may put a number of new style music files together in one play list and test how listeners like this new style music. Yet in another embodiment, the pre-determining mechanism may accept parameters defining a play list from a user. The pre-determining mechanism may have an interface to help a user to enter play list defining parameters, to import a pre-defined play list, and to choose a play list pre-determined by the content provider.

The recommendation mechanism 330 may provide a content provider a way to recommend to a user some MC. The content provider may recommend additional content that is similar or related to a user's preference. The content provider may recommend to a user some other content that might not be even related to a user's preferences to obtain an opinion of the content from the user for marketing purposes. Additionally, the content provider may cross-pollinate a user's play list using play lists from other users. For example, user A and user B have similar preferences, but user A and user B have different titles in their play lists. In this situation, the content provider may recommend those titles in the play list of user B but not in the play list of user A to user A, and vice versa. Through recommendation, a content provider may help a user to expand or modify his play list. At the same time, the content provider may promote certain content for marketing and/or other purposes.

The user feedback uploading mechanism 340 may upload a user's feedback on a play list. The user feedback uploading mechanism might not always be connected to the play list creator. The user's feedback may be about the order of titles in the play list and/or titles recommended by a content provider. When MC in a play list is rendered to a user, the play list creator might not be reachable by the user (e.g., on a trip in a car). Feedback mechanism 150 may record the user's feedback (e.g., rating for each title in the play list) while the MC is rendered. Later when the feedback mechanism is connected to the play list creator, the uploading mechanism may upload the user's feedback so that the play list creator may refine the play list for the user based on the feedback.

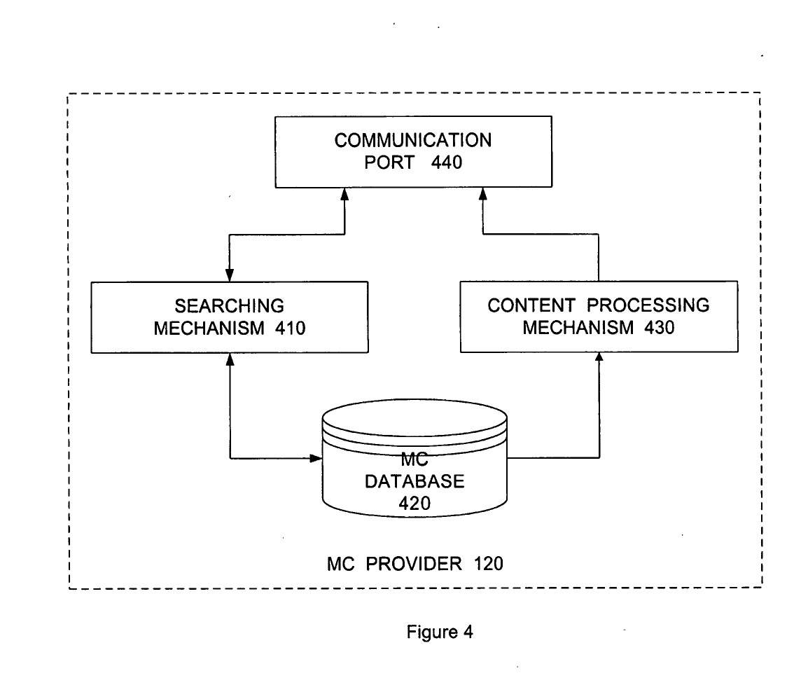

FIG. 4 is a high-level functional block diagram of an MC provider, according to an embodiment of the present invention. The MC provider may comprise a searching mechanism 410, an MC database 420, a content processing mechanism 430, and a communication port 440. The MC database may consist of a large number of multimedia files. The database may contain music files, video files, news files, sports files, etc. The searching mechanism may search the MC database for multimedia files based on their titles in a submitted play list. In case a particular title cannot be found in the MC database, the MC provider may inform the user through the play list creator. In fact, the MC provider may recommend other titles that are similar or related to the requested title to the user. The user may accept or reject the recommended titles and accordingly modify his play list. Once the user desired multimedia files are found, the searching mechanism may pass the files to the content processing mechanism 430. The content processing mechanism may package these files together in an order specified in the user's play list, in a manner required by a network protocol, or in a manner necessary for efficient transfer across a network. The content processing mechanism may encrypt these multimedia files by using a DRM system, tamper-resistant software, and/or other encryption techniques. The encryption scheme may be distinct for each multimedia file to achieve a better protection. The content processing mechanism may also compress and/or encode the multimedia files so that the bandwidth of the transmission channel between the MC provider and an MC cache may be more efficiently used.

In one embodiment, the packaging process conducted by the content processing mechanism may comprise providing a header for a multimedia file, which may contain introductory information of the file. The MC player may first play the header before rendering the entire multimedia file. A user may learn more about the multimedia file through the header and may decide to skip or continue playing the multimedia file. In another embodiment, the packaging process may bundle a player application and an auto-installer script along with multimedia files. The packaging process may further bundle a decryption, decompression, and/or decoding application along with the multimedia files, if the multimedia files are encrypted, compressed, and/or encoded. When a user downloads the bundled package to a computer, the auto-installer may automatically install and execute the player application as well as the decryption, decompression, and/or decoding application if necessary. The computer here works as an MC cache but with the capability of executing an auto-installer. The bundled package may be self-contained and make the multimedia files easier to be rendered and harder to be tampered.

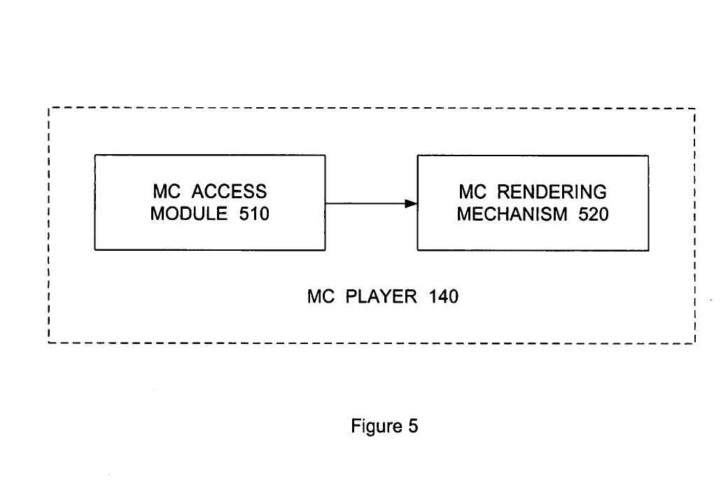

FIG. 5 is a high-level functional block diagram of an MC player that accesses and renders multimedia content in an MC cache, according to an embodiment of the present invention. The MC player may comprise an MC access module 510 and an MC rendering mechanism 520. The MC access module may unpack, decrypt, decompress, and/or decode multimedia files in an MC cache. The MC access module may unpack the multimedia files according to the network protocol. Depending on an encryption scheme for each file, the access module may need to decrypt each file distinctively. The MC rendering mechanism may render the multimedia files to a user. The MC rendering mechanism may allow the user to interact with it during rendering. For example, the user may fast forward, rewind, skip, pause, and/or stop playing a multimedia file.

Although an example embodiment of the present invention is described with reference to block and flow diagrams in FIGS. 1-5, persons of ordinary skill in the art will readily appreciate that many other methods of implementing the present invention may alternatively be used. For example, the order of execution of the blocks in flow diagrams may be changed, and/or some of the blocks in block/flow diagrams described may be changed, eliminated, or combined.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features, components, or modules were omitted, simplified, combined, or split in order not to obscure the present invention.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system embodying the playback device components includes any system that has a processor, such as, for example, a digital signal processor (DSP), a micro-controller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a removable storage media or device (e.g., floppy disk drive, read only memory (ROM), CD-ROM device, flash memory device, DVD, or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method for caching multimedia content to an occasionally-connected device, comprising:
creating a play list based at least in part on a user's preferences;
submitting the play list to a multimedia content provider through a network;
downloading multimedia content in the play list to a device when the device is connected to the multimedia content provider and caching the multimedia content on the device; and
playing the cached multimedia content while the device is not connected to the multimedia content provider.
